(19) United States
(12) Patent Application Publication
(10) Pub. No.: US 2025/0188260 A1
(43) Pub. Date: Jun. 12, 2025

(54) RECYCLABLE SHEET MOLDING COMPOUND USING LIQUID THERMOPLASTIC (METH) ACRYLIC RESIN

(71) Applicant: Magna Exteriors Inc., Aurora (CA)

(72) Inventors: Ranjit Pachha, Brampton (CA); Siddhartha Asthana, Ann Arbor, MI (US)

(73) Assignee: Magna Exteriors Inc., Aurora, ON (CA)

(21) Appl. No.: 18/847,176

(22) PCT Filed: Mar. 17, 2023
(86) PCT No.: PCT/US2023/064638

§ 371 Date: Sep. 13, 2024

Related U.S. Application Data
(60) Provisional application No. 63/320,866, filed on Mar. 17, 2022.

(51) Int. Cl. C08L 33/10; B29C 70/46; B29K 33/00; C08J 5/04; C08K 7/14

(52) U.S. Cl. CPC C08L 33/10; B29C 70/46; C08J 5/043; C08K 7/14; B29K 2033/12; C08J 2333/10; C08L 2207/20

(57) ABSTRACT

A recyclable sheet molding composition for manufacture of a vehicle part. The sheet molding composition includes 20 to about 50% of a methacrylic thermoplastic resin, 0 to about 20% of low profile additive which is dissolved in monomer or polymeric resin and filled with 20 to 60% reinforcement fibers and a second filler in the amount of 10 to 40%.

### CROSS-REFERENCE TO RELATED APPLICATIONS

This application is a PCT International Patent Application and claims benefit of U.S. Provisional Patent Application No. 63/320,866, filed Mar. 17, 2022. The disclosure of the above application is incorporated herein by reference.

### FIELD OF THE INVENTION

The present invention relates to a recyclable sheet molding compound for (SMC) making recyclable vehicle parts.

### BACKGROUND OF THE INVENTION

Acrylic composites with improved surface properties is set forth in U.S. Publication No. 20210403653. While this is useful it does not provide a substitute for SMC materials when used for manufacture of vehicle panel.

Currently SMC materials are used in various automotive applications. SMC can be used for molding class A surface panels or structural type panels. SMC made of unsaturated polyester, vinyl ester, epoxy and phenolics resin—thermoset resin: cannot be recycled.

Injection molded TPOs are not readily useable due to low mechanical properties low due to no reinforcement. With injection molded glass reinforcement of thermoplastics a class A surface is difficult to achieve, short fiber length and these materials have significantly lower mechanical properties than SMC molded parts due to thermoplastic nature.

Large panels and parts which are desirable for use in vehicles cannot be made by injection molding as high press tonnage pressure is required.

Due to high viscosity of the thermoplastic resin only small amounts of reinforcement can be used.

It is desirable to produce a panel which includes the structural and class A surface advantages of a non-recyclable SMC, but which is recyclable at the end of life.

Therefore, it is desirable to provide a recyclable material for body and closure panel applications include hood, roof, liftgate, decklids, doors, spoilers, running board and fenders.

Other desirable parts include Molded in color or painted truck beds, spare tire wells, tonneau covers, seat frame, package trays, load floors are also manufactured using sheet molding compositions.

Therefore, it is desirable to use a recyclable material which is useful in these applications can be classified as class A or structural application. SMCs are made of thermoset resin like unsaturated polyester, vinyl ester, epoxies or phenolics. These resins once cured cannot be recycled at the end of the life cycle. OEMs are looking for material that can be recycled or reused at the end of their lifecycle. It is an object of the present invention to replace these non-recyclable SMC materials with a recyclable material useful in the applications noted above.

### SUMMARY OF THE INVENTION

A recyclable sheet molding composition for manufacture of a vehicle part. The sheet molding composition includes 20 to about 50% of a methacrylic thermoplastic resin, 0 to about 10% of a low profile additive (LPA) such as polyvinyl acetate or polyester resin and filled with 20 to 60% reinforcement fibers and a second filler in the amount of 10 to 40%. Alternatively, a recyclable sheet molding composition consists of 20-60% methacrylic thermoplastic resin, 0-10% of low profile additive and 40-80% reinforcement fibers with no second filler.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a schematic view of the process of the present invention; and,

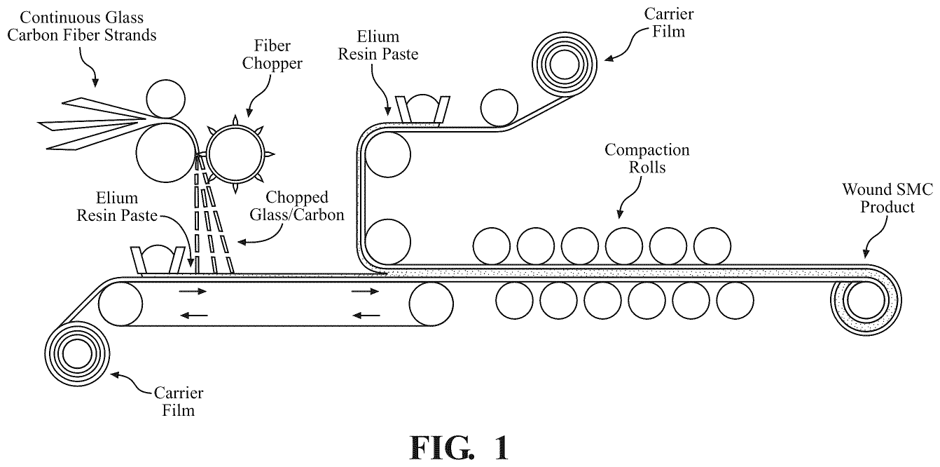

FIG. 2 shows a process of manufacture of a part using the composition of the present invention.

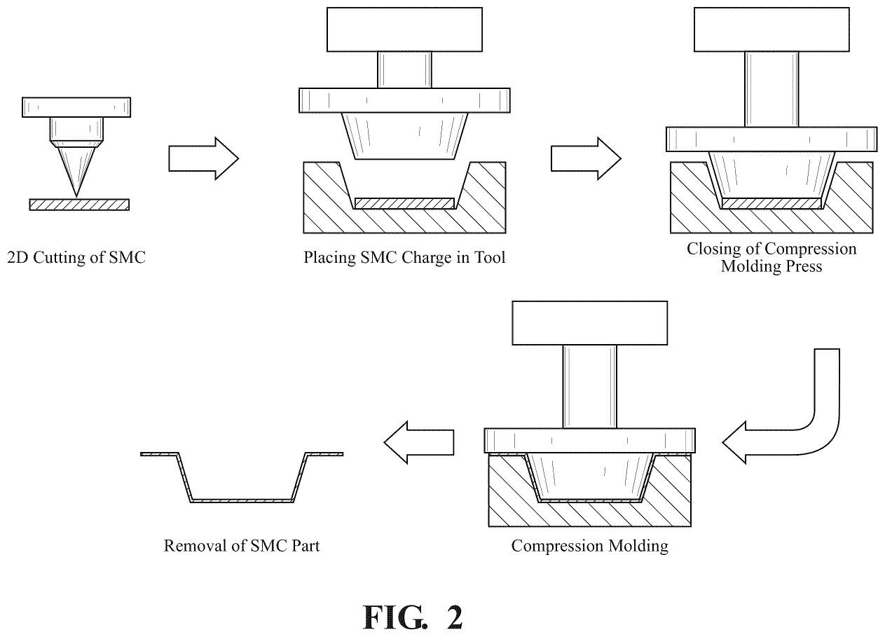

### DETAILED DESCRIPTION OF THE PREFERRED EMBODIMENTS

The following description of the preferred embodiment(s) is merely exemplary in nature and is in no way intended to limit the invention, its application, or uses.

A recyclable sheet molding composition for manufacture of a vehicle part comprising 20 to about 50% and preferably 25 to about 35% of a methacrylic thermoplastic resin, 0 to about 10% of an LPA such as polyvinyl acetate or polyester resin and filled with generally about 20 to 80%, typically from about 20 to 60% and preferably from about 20-30% reinforcement fibers and a second filler in the amount of 10 to 40%. Other incidental release agents, inhibiters, mold release agents, initiators and accelerators are used as needed in the formulation of the material. When used for molding a class A surface the amount of thermoplastic methacrylate resin is from about 20 to 45%. Typical structural recyclable SMC compositions include methacrylic resin in amounts of from about 25 to 50% of the composition. The methacrylic resin element is selected from either styrene or acrylic or methacrylic monomer, Methyl methacrylate monomer, hydroxy methacrylate, Ethylene glycol, dimethacrylate, tert butyl methacrylate, other like monomers and mixtures thereof.

Fiber reinforcements used in the present invention include but are not limited to reinforcement like glass fiber, carbon fiber, basalt or bio-based fiber with length ranging from 0.1″-3.00″.

In one embodiment no secondary fillers are used However, in another embodiment secondary fillers are used. Secondary fillers include calcium carbonates, ATH or other fillers known in the art.

Also provided for in the present invention is a process for manufacture of a recyclable SMC material for making of a recyclable sheet molded panel comprising the steps of:
providing a thermoplastic based SMC resin comprising: 20 to about 50% and preferably 25 to about 35% of a methacrylic thermoplastic resin, 0 to about 10% of an LPA such as polyvinyl acetate or polyester resin and filled with 20-80%, typically 20 to 60% and preferably 20-30% reinforcement fibers and a second filler in the amount of 10 to 40%;
forming an unformed sheet of the composition; and,
using heat and pressure for forming a part.

A process for manufacture of an SMC material for making of a sheet molded panel for a vehicle which is recyclable at the end of life cycle includes the additional steps of using heat for recycling the part after disposal or at end of life of the part. Preferably the parts are recycled by a thermal process in the absence of oxygen. This results in being able to separate the parts into reusable resin, fillers and glass and other reinforcements which were used to make the part.

### EXAMPLES

### Example 1

A recyclable thermoplastic composition useful as a class A vehicle part surface is made using the following formulation.
1. Liquid thermoplastic (Meth)acrylic resin: Elium 150 20-45%
2. LPA: Polyvinyl acetate or Polyester: 0-10%
3. Filler: Calcium Carbon, ATH or other: 10-40%
4. Wetting agent BYK 9010: 0.1-0.6%
5. Inhibitor: 5% P-Benzoquinone: 0.1-0.3%
6. Inhibitor: BHT: 0-0.2%
7. Mold release: Zinc stearate: 0.5-2.0%
8. Accelerator: Cobalt octoate or naphthenate: 0.01-0.09%
9. Initiator: Organic Peroxide: T Butyl perbenzoate (or similar organic peroxide): 0.1-1.5%
10. Reinforcement: Chopped fiberglass: 20-35%

A vehicle part is made using the following parameters:
Tool Temperature: 70-80 C
Tonnage: 700-1400 psi
Charge size: 20-90% of tool coverage
Cure time: 90-300 sec

A class A surface vehicle part is produced. The part is found to be recyclable by thermal decomposition in the lack of oxygen. Resin, fillers, and glass and other reinforcement fibers were obtained.

### Example 2

A recyclable thermoplastic composition useful as a structural vehicle part is made using the following formulation:
Liquid thermoplastic (Meth)acrylic resin: Elium 150 25-50%
LPA: Polyvinyl acetate or Polyester: 0-10%
Filler: Calcium Carbon, ATH or other: 0-20%
Wetting agent BYK 9010: 0.1-0.6%
Inhibitor: 5% P-Benzoquinone: 0.1-0.3%
Inhibitor: BHT: 0-0.2%
Mold release: Zinc stearate: 0.5-2.0%
Accelerator: Cobalt octoate or naphthenate: 0.01-0.09%
Initiator: Organic Peroxide: T Butyl perbenzoate (or similar organic peroxide): 0.1-1.5%
Reinforcement: Chopped fiberglass, Carbon fiber: 30-60%.

A vehicle part is made using the following parameters:
Tool Temperature: 70-80 C
Tonnage: 700-1400 psi
Charge size: 20-90% of tool coverage
Cure time: 90-300 sec

A class structural vehicle part is produced. The part is found to be recyclable first grinding the parts into small pieces and then using thermal decomposition in the absence of oxygen. Resin, fillers, and glass and other reinforcement fibers were obtained.

Therefore, in operation an SMC is made using liquid thermoplastic resin that can be recycled after the end of life cycle. SMC made of low viscosity resin and that can be compression molded into either class A or structural application. SMC made of reinforcement like glass fiber, carbon fiber, basalt or bio-based fiber with length ranging from 0.1″-3.00″.

Formulating SMC with low viscosity thermoplastic (meth)acrylic resin allows the SMC to be formulated as traditional SMC with chopped reinforcement-glass, carbon, basalt or other reinforcement and fillers. The thermoplastic (meth)acrylic resin such as Elium marketed by Arkema is utilized. The SMC can then be compression molded and cured similar to traditional SMC into complex geometries. At the end of the life cycle this SMC can then be recycled by applying heat with and without solvent. The resin and fiber can be separated and both resin and fiber can be reused.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A recyclable sheet molding composition consists of 20-60% methacrylic thermoplastic resin, 0-10% of low profile additive and 40-80% reinforcement fibers with no second filler.

2. The recyclable SMC of claim 1 wherein the methacrylic thermoplastic resin is selected from (meth)acrylic resin, styrene or acrylic or methacrylic monomer, Methyl methacrylate monomer, hydroxy methacrylate, Ethylene glycol, dimethacrylate, tert butyl methacrylate, other like monomers and mixtures thereof.

3. The recyclable SMC resin of claim 1 which is used for molding a class A surface wherein said thermoplastic methacrylate resin is from about 20 to 45%

4. The recyclable SMC resin of claim 1 wherein a structural SMC is provided wherein the methacrylic resin is from about 25-50% of the composition.

5. A process for manufacture of a recyclable SMC material for making of a sheet molded panel comprising the steps of:
A. providing a thermoplastic based SMC resin comprising: 20 to about 50% of a methacrylic thermoplastic resin, 0 to about 10% of a thermoset resin such as polyvinyl acetate or polyester resin and filled with 20 to 80% reinforcement fibers and optionally a second filler in the amount of 10 to 40%;
B. forming an unformed sheet of the composition of step A; and,
C. using heat and pressure for forming a part.

6. A process for manufacture of an SMC material for making of a sheet molded panel comprising the steps of:
A. providing a thermoplastic based SMC resin comprising: 20 to about 50% of a methacrylic thermoplastic resin, 0 to about 10% of a thermoset resin such as polyvinyl acetate or polyester resin and filled with 20 to 60% reinforcement fibers and a second filler in the amount of 10 to 40%;
B. forming an unformed sheet of the composition of step A;
C. using heat and pressure for forming a part; and,
D. using heat for recycling the part after disposal or at end of life of the part.

7. The process of claim 6 wherein heat in the absence of oxygen is used to decompose the recyclable material.

8. The process of claim 7 further comprising also using a solvent for dissolution of grinded part and then distillation of solvent to recover the recyclable material.

9. A recyclable sheet molding composition for manufacture of a vehicle part comprising 20 to about 50% of a methacrylic thermoplastic resin, 0 to about 10% of a low profile additive and filled with 20 to 60% reinforcement fibers and a second filler in the amount of 10 to 40%.

10. The recyclable SMC of claim 9 wherein low profile additive is selected from (meth)acrylic resin, styrene or acrylic or methacrylic monomer, Methyl methacrylate monomer, hydroxy methacrylate, Ethylene glycol, dimethacrylate, tert butyl methacrylate, other like monomers and mixtures thereof.

11. The recyclable SMC resin of claim 9 which is used for molding a class A surface wherein said thermoplastic methacrylate resin is from about 20 to 45%.

12. The recyclable SMC resin of claim 9 wherein a structural SMC is provided wherein the methacrylic resin is from about 25-50% of the composition.
